(19) United States
(12) Patent Application Publication
(10) Pub. No.: US 2023/0234135 A1
(43) Pub. Date: Jul. 27, 2023

(54) PLANNING DEVICE AND METHOD FOR PLANNING A LOCALLY SELECTIVE IRRADIATION OF A WORK REGION USING AN ENERGY BEAM, COMPUTER PROGRAM PRODUCT FOR CARRYING OUT SUCH A METHOD, MANUFACTURING DEVICE HAVING SUCH A PLANNING DEVICE, AND METHOD FOR THE ADDITIVE MANUFACTURE OF A COMPONENT FROM A POWDER MATERIAL

(71) Applicant: TRUMPF Laser- und Systemtechnik GmbH, Ditzingen (DE)

(72) Inventors: Sarah Leuck, Ludwigsburg (DE); Wilhelm Meiners, Aachen (DE)

(21) Appl. No.: 18/295,281

(22) Filed: Apr. 4, 2023

Related U.S. Application Data
(63) Continuation of application No. PCT/EP2021/076485, filed on Sep. 27, 2021.

(30) Foreign Application Priority Data
Oct. 9, 2020 (DE) 10 2020 006 216.4
Oct. 30, 2020 (DE) 10 2020 213 711.0

(51) Int. Cl. B22F 10/366; B33Y 50/02; B33Y 30/00; B22F 12/90; B22F 10/85; B22F 12/45; B22F 12/49; B22F 10/28; B23K 26/342

(52) U.S. Cl. CPC B22F 10/366; B33Y 50/02; B33Y 30/00; B22F 12/90; B22F 10/85; B22F 12/45; B22F 12/49; B22F 10/28; B23K 26/342; B23K 26/073

(57) ABSTRACT

A planning device for planning locally selective irradiation of a work region using an energy beam in order to produce a component from a powder material arranged in the work region is provided. The planning device is configured to obtain a plurality of irradiation vectors for irradiating a powder material layer arranged in the work region with the energy beam. The planning device is further configured to determine a vector alignment in a coordinate system on the work region for at least one irradiation vector of the plurality of irradiation vectors, and to specify, for the at least one irradiation vector, a beam alignment for a non-circular beam shape of the energy beam on the work region relative to the vector alignment of the at least one irradiation vector.

### CROSS REFERENCE TO RELATED APPLICATIONS

This application is a continuation of International Application No. PCT/EP2021/076485 (WO 2022/073785 A1), filed on Sep. 27, 2021, and claims benefit to German Patent Application No. DE 10 2020 006 216.4, filed on Oct. 9, 2020 and to German Patent Application No. DE 10 2020 213 711.0, filed on Oct. 30, 2020. The aforementioned applications are hereby incorporated by reference herein.

### FIELD

Embodiments of the present invention relate to a planning device and to a method for planning a locally selective irradiation of a work region with an energy beam, to a computer program product for carrying out such a method, to a manufacturing device having such a planning device and to a method for the additive manufacture of a component from a powder material.

### BACKGROUND

During the additive manufacture of components from a powder material, an energy beam is typically displaced selectively to predetermined irradiation positions of a work region in order to locally solidify powder material arranged in the work region. In particular, this is repeated layer-by-layer in powder material layers successively arranged in the work region in order to ultimately obtain a three-dimensional component made of solidified powder material.

The locally selective irradiation of the work region is planned in advance and/or ad hoc during manufacture, but typically before the actual irradiation of a powder material layer. A planning device that carries out this planning is provided to this end. It was found that, under certain conditions and at least for certain regions of the component to be produced, it may be advantageous to use a non-circular beam shape for the energy beam on the work region, for example to increase the construction rate. However, this necessitates the alignment of the corresponding beam shape, which is no longer rotationally symmetric vis-à-vis a rotation through any angle, relative to a displacement direction of the energy beam. Conventional planning devices and methods for planning the locally selective irradiation of the work region are not configured to this end.

### SUMMARY

Embodiments of the present invention provide a planning device for planning locally selective irradiation of a work region using an energy beam in order to produce a component from a powder material arranged in the work region. The planning device is configured to obtain a plurality of irradiation vectors for irradiating a powder material layer arranged in the work region with the energy beam. The planning device is further configured to determine a vector alignment in a coordinate system on the work region for at least one irradiation vector of the plurality of irradiation vectors, and to specify, for the at least one irradiation vector, a beam alignment for a non-circular beam shape of the energy beam on the work region relative to the vector alignment of the at least one irradiation vector.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of one exemplary embodiment of a manufacturing device for additive manufacturing of components from a powder material, having an exemplary embodiment of a planning device;

FIG. 2 shows a schematic illustration of a first embodiment of a method for planning locally selective irradiation of a work region, and

FIG. 3 shows a schematic illustration of a second embodiment of such a method.

### DETAILED DESCRIPTION

Embodiments of the present invention provide a planning device and a method for planning a locally selective irradiation of a work region using an energy beam, a computer program product for carrying out such a method, a manufacturing device having such a planning device, and a method for the additive manufacture of a component from a powder material.

Embodiments of the present invention provide a planning device for planning locally selective irradiation of a work region using an energy beam in order to produce a component by means of the energy beam from a powder material arranged in the work region, with the planning device being configured to obtain a plurality of irradiation vectors for irradiating, by means of the energy beam, a powder material layer arranged in the work region, the planning device being configured to determine a vector alignment in a coordinate system on the work region for at least one irradiation vector of the plurality of irradiation vectors, and the planning device being configured to specify, for the at least one irradiation vector, a beam alignment for a non-circular beam shape of the energy beam on the work region relative to the vector alignment of the at least one irradiation vector. This allows at least regional use of a non-circular beam shape for the energy beam, with the result that the advantages connected therewith, in particular an increased construction rate, are able to be obtained. Moreover, it is possible to obtain a more stable process and/or an improved component quality, in particular a better surface quality, less warpage, and an avoidance of, or a reduction in, cracks.

The planning device being configured to obtain the plurality of irradiation vectors includes, in particular, the planning device having an interface or any other suitable design for having the irradiation vectors transmitted thereto or for receiving the irradiation vectors—preferably electronically, in particular in the form of a file or other machine-readable data, in particular wirelessly or in wired fashion. However, this also includes the planning device being configured to create or generate, in particular calculate, the irradiation vectors. In particular, it is possible for a computer program to be able to be executed on the planning device itself, by means of which computer program the irradiation vectors can be calculated or generated in some other way. It is also possible for the irradiation vectors to be input into the planning device by a user, whether manually, through speech input, through gestures or in any other suitable manner. The planning device being configured to obtain the irradiation vectors accordingly means, in particular, that the irradiation vectors can be provided or made accessible to the planning device in any way, with this including the irradiation vectors being able to be generated in the planning device itself.

In particular, the planning device is configured to ascertain the vector alignment for the at least one irradiation vector.

A beam shape of the energy beam on the work region is understood to mean, in particular, an intensity distribution of the energy beam on the work region, in particular on the powder material layer.

Preferably, a non-circular beam shape is, in particular, a beam shape which has a first width along a first direction which is greater than a second width of the beam shape along a second direction, with the second direction being perpendicular to the first direction. Thus, in particular, the non-circular beam shape is a stretched-out or elongate beam shape. The elongate beam shape is preferably aligned with the first width along the displacement direction of the energy beam, that is to say along the vector alignment. According to a preferred configuration, the non-circular beam shape has the form of an ellipse. In this case, the elliptical beam shape is preferably aligned with its semi-major axis along the vector alignment.

In particular, the planning device is configured to define the beam alignment relative to the vector alignment for the at least one irradiation vector.

In particular, the beam alignment is given by an angle between the beam shape and a specific axis of the coordinate system on the work region. By contrast, the term “beam orientation” used below describes an orientation along a direction defined by the beam alignment of a beam shape which is not symmetric along the beam alignment, and consequently, as it were, the case whether the beam shape is oriented “forwards” or “backwards”—in particular in view of a displacement direction of the beam shape.

The planning device being designed to specify, more particularly define, the beam alignment for the at least one irradiation vector means, in particular, that the planning device is configured to generate, for the at least one irradiation vector, a control variable, in particular an angle, for controlling an optics device, with the beam shape of the energy beam being able to be aligned on the work region by means of the said optics device.

It is possible that the planning device is configured to determine a vector alignment for each irradiation vector of the plurality of irradiation vectors. This is advantageous, in particular, if all irradiation vectors are assigned a non-circular beam shape or if the non-circular beam shape is fixedly specified for all irradiation vectors. However, it is also possible for the planning device to be configured to determine the vector alignment for a number of irradiation vectors, with the number being smaller than the number of the plurality of irradiation vectors. In particular, it is possible for the planning device to be configured to determine the vector alignment only for those irradiation vectors which are also assigned a non-circular beam shape. In this way, it is advantageously possible, in particular, to save computational power and optionally also storage space since there is no need to determine the vector alignment for those irradiation vectors which are assigned a circular beam shape.

The planning device is preferably formed, in particular, as a build processor, in particular externally to a manufacturing device, or as a control device, in particular as an internal control device, of a manufacturing device for the additive manufacture of a component from a powder material. In this case, a build processor should be understood to mean, in particular, a device which generates a data set or a file with data that can be transferred to a control device of a manufacturing device so that the manufacturing device can additively manufacture a component from a powder material on the basis of the data. Especially if the planning device is in the form of a build processor, it generates the irradiation vectors itself in a preferred configuration. By contrast, if the planning device is in the form of a control device of a manufacturing device, it preferably receives the irradiation vectors from a build processor, in particular as a data set and/or in the form of a file. However, the planning device may also be provided in part in the build processor and in part in the control device of the manufacturing device. In particular, steps of the method according to embodiments of the invention for planning the locally selective irradiation, or of one or more embodiments of this method, which are described in the context of the planning device can be carried out in the build processor, in the control device or partly in the build processor and partly in the control device.

In particular, the planning device is preferably selected from the group consisting of a computer, in particular a personal computer (PC), a mobile computing device, for example a tablet or smartphone, a plug-in card or control card, and an FPGA board. In one preferred configuration, the planning device is an RTC6 control card from SCANLAB GmbH, in particular in the current configuration obtainable on the priority date of the present property right. However, the planning device may also be implemented as a service provider, that is to say a server in particular, or as a plurality of networked computing devices, in particular as a network or part of a network, in particular as a cloud or part of a cloud.

Additive or generative manufacture or production of a component is understood to mean in particular building up a component layer-by-layer from powder material—powder material layer by powder material layer—, in particular a powder-bed-based method for producing a component in a powder bed, in particular a manufacturing method selected from a group consisting of selective laser sintering, selective polymer laser sintering, laser metal fusion (LMF), direct metal laser melting (DMLM), direct metal laser sintering (DMLS), laser net shaping manufacturing (LNSM), laser engineered net shaping (LENS) and electron beam melting (EBM)—in particular selective electron beam melting.

In general, an energy beam is understood to mean directed radiation that is able to transport energy. In general, this may be particle radiation or wave radiation. In particular, the energy beam propagates through physical space along a propagation direction and transports energy along its propagation direction in the process. In particular, local deposition of energy in the work region is possible by way of the energy beam.

In a preferred configuration, the energy beam is an electron beam or optical work beam. An optical work beam is understood to mean in particular directed, either continuous or pulsed, electromagnetic radiation which, in terms of its wavelength or a wavelength range, is suitable for additive or generative manufacturing of a component from powder material, in particular for sintering or melting the powder material. An optical work beam is understood to mean in particular a laser beam that can be produced in a continuous, pulsed or modulated fashion. The optical work beam preferably has a wavelength or a wavelength range within the visible electromagnetic spectrum or within the infrared electromagnetic spectrum or within the overlap range between the infrared range and the visible range of the electromagnetic spectrum.

A work region is understood to mean in particular a region, in particular a plane or surface, in which the powder material layer is arranged and which is locally irradiated with the energy beam to locally solidify the powder material. The powder material is in particular arranged sequentially in layers in the work region and irradiated locally with the energy beam in order to produce a component layer by layer.

An energy beam acting locally on the work region means in particular that the energy beam does not act on the entire work region globally—neither instantaneously nor sequentially—but rather that the energy beam acts on the work region at certain locations, in particular at individual locations that are contiguous or separate from one another, wherein the energy beam is in particular displaced within the work region by way of the scanner device. The energy beam acting selectively on the work region means in particular that the energy beam acts on the work region at selected, predetermined locations or places or in selected, predetermined regions. The work region is in particular a powder material layer or a preferably contiguous area of a powder material layer that the energy beam is able to reach with the aid of the scanner device, that is to say it comprises in particular locations, places or regions of the powder material layer on which the energy beam is able to act.

An irradiation vector is understood to mean, in particular, a certain segment in the work region, along which a continuous, more particularly linear displacement of the energy beam is carried out, the segment having a certain length, a certain displacement direction, optionally at least regionally a certain curvature or a certain non-linear path and a certain orientation of the displacement. Thus, the irradiation vector preferably includes the direction or alignment as its vector alignment, the length as its vector length and the orientation—that is to say “forwards” or “backwards” along the alignment—of the displacement as its vector orientation.

The displacement being implemented continuously means in particular that it is implemented without stopping or interrupting the energy beam, in particular without any jumps. The irradiation being implemented linearly means in particular that it is implemented along a straight line.

Preferably, such an irradiation vector is represented at least—preferably represented exactly—by the specification of a start point and an endpoint in the coordinate system spanned over the work region. In particular, the planning device is configured to determine, in particular calculate, the vector alignment of an irradiation vector, and preferably also at least one further variable selected from its vector length and its vector orientation, from the start point and the endpoint of the said irradiation vector. Especially if an irradiation vector has a curvature at least regionally or approximates a curved path by piecewise juxtaposition of linear portions, it is possible for the irradiation vector to be described by at least one further path parameter, for example a plurality of intermediate points between the start point and the endpoint. In particular, it is also possible for an irradiation vector to be defined by a plurality of contiguous partial vectors.

In particular, the vector alignment is an angle—at least locally—between the irradiation vector and a certain axis of the coordinate system. The vector orientation—as already explained—comprises the—at least local—direction of the displacement of the energy beam along the irradiation vector or, phrased differently, the question of which of the points defining the irradiation vector is the start point for the displacement and which is the endpoint.

According to embodiments of the invention, provision is made for the planning device to be configured to specify a beam shape of the energy beam for each irradiation vector of the plurality of irradiation vectors, in particular to allocate a beam shape to each irradiation vector of the plurality of irradiation vectors. In so doing, it is possible, in principle, for each irradiation vector to be allocated the same beam shape. However, it is also possible to allocate different beam shapes to different irradiation vectors, which may be advantageous in respect of increasing the flexibility of the manufacture in particular. Moreover, this allows the choice of optimal manufacturing parameters, especially on the basis of certain local conditions. In particular, the planning device is preferably configured to specify, in particular allocate, either a circular beam shape or a non-circular beam shape of the energy beam to each irradiation vector of the plurality of irradiation vectors.

As an alternative or in addition, the planning device is configured to specify, in particular allocate, an energy input parameter of the energy beam to each irradiation vector of the plurality of irradiation vectors. The at least one energy input parameter is preferably selected from the group consisting of a beam power and a displacement speed of the energy beam on the work region, in particular within an irradiation vector from its start point to its endpoint. This was found to be particularly advantageous if each irradiation vector is assigned the same beam shape. Then, in particular, it is possible to take account of different local conditions by way of a different choice of the energy input parameter in each case.

According to some embodiments, provision is made for the planning device to be configured to ascertain the vector orientation for at least one irradiation vector of the plurality of irradiation vectors. The planning device is preferably further configured to specify, for the at least one irradiation vector, a beam orientation for the beam shape assigned to the at least one irradiation vector—relative to the vector orientation. This also allows use of a beam shape that is non-symmetrical in the direction of the vector alignment, with the result that it requires a specification of the orientation of the beam shape relative to the vector orientation in order to uniquely define the pose of the beam shape, in particular in view of the displacement direction of the energy beam. It is thus also possible to use beam shapes that are non-symmetrical along the vector alignment. Hence, the flexibility of manufacture can be further increased.

The planning device is preferably configured to ascertain the vector orientation for the irradiation vector or the irradiation vectors for which the vector alignment is also determined. In particular, these are the irradiation vectors for which a non-circular beam shape is used as well. In a preferred configuration, it is possible for the planning device to be configured to ascertain a vector orientation for only those irradiation vectors for which use is also made of a beam shape that is non-symmetrical in the direction of the vector alignment.

According to some embodiments, provision is made for the planning device to be configured to allocate to each of at least two irradiation vectors of the plurality of irradiation vectors a different beam shape on the basis of at least one vector parameter, the at least one vector parameter preferably being selected from a group consisting of: a location of the irradiation vector on the work region, an assignment of the irradiation vector to a specific vector group and a vector length of the irradiation vector.

As an alternative or in addition, the planning device is configured to allocate to each of at least two irradiation vectors of the plurality of irradiation vectors a different energy input parameter on the basis of the at least one vector parameter.

If the location of the irradiation vector on the work region is used as the vector parameter, this allows local conditions to be taken into account when choosing the beam shape or the energy input parameter. Taking account of the assignment of the irradiation vector to a certain vector group as vector parameter allows local manufacturing conditions or conditions of the component being created, in particular also conditions of the three-dimensional geometry of the component being created, to be advantageously taken into account. Taking account of the vector length as a vector parameter is advantageous since a non-circular beam shape can be disadvantageous, especially in the case of comparatively short irradiation vectors, in particular if an elongate length of the beam shape is approximately the same size as the vector length of the irradiation vector. In that case, it is found to be advantageous, in particular, to accordingly assign a circular beam shape to comparatively short irradiation vectors. The described procedure is particularly suitable for a configuration of the planning device as a control device of a manufacturing device or for an implementation of the planning device in such a control device.

Assigning an irradiation vector to a specific vector group is understood to mean, in particular, whether the irradiation vector is assigned to a component contour as a contour vector, whether the irradiation vector is assigned to a delicate component structure or whether the irradiation vector is assigned to a support structure for the component to be produced, to a volume region or “in skin” region, an overhang region or “down skin” region or a cover layer region or “up skin” region of the powder material layer. Respectively different manufacturing conditions arise in the corresponding regions, and these can advantageously be taken into account appropriately by a suitable choice of the beam shape and/or energy input parameter. By way of example, a reduced spatial and temporal energy input is required for certain critical structures, for example for certain support structures, in order to avoid local overheating, for example. In this case, a circular beam shape, in particular, may be advantageous vis-à-vis a non-circular beam shape. In this respect, the planning device is particularly preferably configured to identify corresponding component regions, in particular critical component regions, to assign the irradiation vectors to the corresponding vector groups, and to choose in each case a suitable beam shape and/or a suitable energy input parameter for the irradiation vectors.

An overhang region is, in particular, a region within a powder material layer, below which, that is to say in powder material layers located therebelow, non-solidified powder material is present. Such an overhang is also referred to as “down skin.” A cover layer region is, in particular, a region within a powder material layer, above which, that is to say in powder material layers located thereabove, non-solidified powder material is present. Such a cover layer region is also referred to as “up skin.” This term also denotes the uppermost powder material layer that still comprises solidified powder material, that is to say a roof surface or uppermost surface of the component. A volume region is, in particular, a region within a powder material layer that is surrounded by solidified powder material on all sides, in particular within the powder material layer but also above and below the powder material layer just processed, in the finished component part. Such a region is also referred to as “in skin” region.

According to some embodiments, provision is made for the planning device to be configured to define a plurality of irradiation regions on the work region and assign the irradiation vectors to the irradiation regions, with the planning device being configured to specify a beam shape of the energy beam for each irradiation region of the plurality of irradiation regions and to define a division of the irradiation regions on the basis of a vector length of the irradiation vectors in the irradiation regions. This procedure is particularly suitable if the planning device is in the form of a build processor. By way of example, it is possible in that case to produce or specify strip-shaped irradiation regions, with each irradiation region being assigned a certain beam shape. If the beam shape should then be modified on the basis of the vector length, this is particularly easily possible if a new irradiation region is defined beyond a certain limit vector length, in particular towards shorter irradiation vectors, or if an existing irradiation region is split into a first region with longer irradiation vectors and a second region with shorter irradiation vectors. By way of example, the irradiation regions may also be relatively small rectangular or square regions, for example in a chequerboard style.

The planning device being configured to define a plurality of irradiation regions on the work region and assign the irradiation vectors to the irradiation regions means, in particular, that the planning device may be configured to allocate existing irradiation vectors to different irradiation regions. As an alternative or in addition, the planning device may be configured to generate new irradiation vectors in different irradiation regions.

An irradiation region is in particular passed over sequentially with a multiplicity of irradiation vectors. In particular, a strip-shaped irradiation region is preferably passed over sequentially by a multiplicity of irradiation vectors that are aligned in the width direction of the irradiation region and arranged offset from one another or next to one another in the longitudinal direction of the irradiation region. In this case, adjacent irradiation vectors may in particular be oriented parallel or antiparallel to one another.

According to some embodiments, provision is made for the planning device to be configured to specify, for at least one irradiation vector of the plurality of irradiation vectors and on the basis of at least one distance parameter, at least one contour distance of the at least one irradiation vector from a contour line of a component contour of a component layer to be produced on the powder material layer in the work region, the at least one distance parameter being selected from the group consisting of: the beam shape assigned to the at least one irradiation vector and a contour angle between the at least one irradiation vector and the contour line. Preferably, the planning device is configured to specify the at least one contour spacing on the basis of both distance parameters of the aforementioned group. Preferably, the planning device is configured so that an operator can parameterize the at least one contour distance or can specify conditions for the specification of the at least one contour distance, for example in the form of a table or characteristic map.

A component contour is understood here to mean a boundary line or border line of a component layer or of a region of the component layer.

A component layer is understood here to mean a layer of the resulting component that is still to be produced or has already been produced in the work region in the powder material layer arranged there, that is to say in particular—after the powder material layer has finished being irradiated—those regions thereof in which the powder material has been solidified by the energy beam, in particular sintered or melted. In the course of the additive manufacturing method, the component is built up successively component layer by component layer from the powder material layers arranged above one another.

The at least one contour distance is preferably a minimum distance between the centre or centroid of the beam shape and the contour line. In particular, the contour distance may be given from an intensity maximum of the beam shape. Alternatively, the contour distance may be given from a predetermined boundary or contour line, which for example runs at a given percentage of the maximum intensity. In principle, multiple definitions for the contour distance are possible, but in end effect these physically have the same meaning. Consequently, the contour distance in particular defines where the at least one irradiation vector must start or end in relation to the contour line. Consequently, the contour distance depends on the extent of the beam shape in particular. In particular, the contour distance is advantageously chosen on the basis of the specific beam shape, with it being chosen, in particular, on the basis of a deviation of the beam shape from the circular form. If the beam shape is non-circular, a suitable choice of the contour distance depends, in particular, on the contour angle between the at least one irradiation vector, and hence also the beam shape itself, and the contour line. It is possible that two contour distances are determined for one irradiation vector, in particular a first contour distance along the vector alignment and a second contour distance perpendicular to the vector alignment. Since the beam shape is preferably elongate along the vector alignment, the first contour distance is preferably chosen to be greater than the second contour distance. However, if the beam shape along the vector alignment is non-symmetrical, different contour distances—optionally more than two contour distances in particular—are chosen preferably on the basis of the beam shape, with values of the different contour distances then possibly also depending on the beam orientation in particular.

According to some embodiments, provision is made for the planning device to be configured to carry out the determination of the vector alignment and the specification of the beam alignment for each component layer of a plurality of the component layers to be produced successively in the work region. In this case, it may be found to be advantageous, in particular, if the vector alignment and hence simultaneously also the beam alignment, in particular, varies from component layer to component layer. In a particularly simple configuration, it is possible for the irradiation vectors or irradiation regions with the irradiation vectors to be rotated through a predetermined angle from component layer to component layer. Then, the planning device is configured in particular to also rotate the beam alignment appropriately.

According to some embodiments, provision is made for the planning device to be configured to specify, on the basis of at least one contour travel parameter, a number of displacements of the energy beam along a contour line of a component contour of a component layer to be produced on the powder material layer in the work region, the at least one contour travel parameter being selected from a group consisting of: the beam shape assigned to at least one irradiation vector adjacent to the contour line and a contour angle between the at least one irradiation vector adjacent to the contour line and the contour line. According to a preferred configuration, the planning device is configured to specify the number of displacements of the energy beam along the contour line on the basis of both contour travel parameters of the aforementioned group. A displacement of the energy beam along a contour line, which is also referred to as contour travel, is implemented, in particular, in order to smooth the contour defined less accurately in comparison with inner component regions on account of the discrete irradiation vectors ending in the region of the contour line, and to rectify unevenness and/or porosity that has arisen there. Depending on the contour angle and the beam shape, and in particular also depending on the contour distance which in turn depends on these parameters, the contour line is defined better or less well. Depending thereon, it in turn subsequently requires a greater number or a fewer number of contour travels in order to obtain a high quality component contour. In particular, the number of contour travels is chosen to be greater if the contour distance is greater and the number of contour travels is chosen to be less if the contour distance is shorter.

In particular, no additional contour travels in addition to a number of contour travels provided in any case are preferably implemented in the case of a contour distance that is shorter than a predetermined limit contour distance, while additional contour travels are implemented in the case of a contour distance that is greater than or equal to the predetermined limit contour distance. As an alternative or in addition, no additional contour travels are preferably implemented in the region of the circular beam shape whereas additional contour travels are implemented in those regions where the beam shape is non-circular.

According to some embodiments, provision is made for the planning device to be configured to allocate—in particular fixedly allocate—a specific beam shape to each energy beam of a plurality of energy beams, and to assign to the irradiation vectors a respective energy beam of the plurality of energy beams with corresponding beam shape. Different beam shapes can be realized very easily in this way, in particular in what is known as a multi-laser machine. Here, there is no need to control an adjustable or otherwise controllable optics device for the purposes of changing the beam shape; instead, all that is needed is the use of a different energy beam. Optionally, it may even be possible to entirely dispense with adjustable and/or controllable optics devices.

By contrast, if only one energy beam is available, the beam shape is preferably switched over by virtue of a suitable optics device or a corresponding optical element being suitably controlled or—in a particularly simple embodiment—being inserted into or retracted from a beam path of the energy beam as required.

Embodiments of the present invention also provide a method for planning locally selective irradiation of a work region using an energy beam in order to produce a component by means of the energy beam from a powder material arranged in the work region, with a vector alignment in a coordinate system on the work region being determined for at least one irradiation vector of a plurality of irradiation vectors for irradiating, using the energy beam, a powder material layer arranged in the work region, and, for the at least one irradiation vector, a beam alignment for a non-circular beam shape of the energy beam on the work region relative to the vector alignment of the at least one irradiation vector being specified. In particular, the advantages that have already been explained in connection with the planning device are realized in connection with the method.

The method preferably comprises at least one method step, preferably a plurality of method steps, which were explicitly or implicitly described in conjunction with the planning device, in particular in the form of preferred configurations or setups of the planning device.

According to a preferred configuration, it is possible for the planning, or at least partial steps of the planning, of the locally selective irradiation to be carried out at the start of the manufacturing process, in particular before an irradiation of a first powder material layer using the energy beam. Alternatively, it is preferably possible for the planning, or at least partial steps of the planning, to be in each case carried out layer-by-layer during the irradiation of a powder material layer using the energy beam, for the subsequent powder material layer. Alternatively, it is preferably possible for the planning, or at least partial steps of the planning, to be carried out during a powder application for producing a new powder material layer above a just irradiated powder material layer. Finally, it is preferably also possible for the planning, or at least partial steps of the planning, in particular the specification of the beam alignment or the determination of the vector alignment and the specification of the beam alignment, to be carried out in real-time during the irradiation of a powder material layer, for the currently irradiated powder material layer.

Embodiments of the present invention also provide a manufacturing device for the additive manufacture of components from a powder material. The manufacturing device has a beam producing device configured to produce an energy beam. Moreover, the manufacturing device has a scanner device which is configured to locally selectively irradiate a work region with the energy beam in order to produce, by way of the energy beam, a component from the powder material arranged in the work region. Furthermore, the manufacturing device has an optics device which is configured to shape and align the energy beam. Finally, the manufacturing device has a control device that is operatively connected to the scanner device and is configured to control the scanner device. The control device is moreover operatively connected to the optics device in order to control the optics device which is designed to be controllable. The control device has a planning device according to embodiments of the invention or a planning device according to one or more of the above-described exemplary embodiments, or is embodied as a planning device according to embodiments of the invention or as a planning device according to one or more of the above-described exemplary embodiments. In particular, the advantages that have already been explained above in connection with the planning device and the planning method are afforded in connection with the manufacturing device.

The beam producing device is preferably designed as a laser. The energy beam is thus advantageously produced as an intensive beam of coherent electromagnetic radiation, in particular coherent light. In this respect, irradiation preferably means exposure. Alternatively, the beam producing device according to a preferred configuration is designed as an electron gun. Consequently, the energy beam is advantageously generated as an electron beam.

The scanner device preferably has at least one scanner, in particular a galvanometer scanner, a piezo scanner, a polygon scanner, a MEMS scanner, capacitor plates and/or a work head or treatment head able to be displaced relative to the work region. The scanner devices proposed here are especially suitable for displacing the energy beam between a plurality of irradiation positions within the work region.

A work head or treatment head which is displaceable relative to the work region is understood here to mean in particular an integrated component of the manufacturing device which has at least one radiation outlet for at least one energy beam, the integrated component, that is to say the work head, as a whole being displaceable along at least one displacement direction, preferably along two mutually perpendicular displacement directions, relative to the work region. Such a work head may in particular be embodied with a gantry design or be guided by a robot. The work head may in particular be designed as a robot hand of a robot.

The control device is preferably selected from a group consisting of a computer, in particular a personal computer (PC), a plug-in card or control card, and an FPGA board. In one preferred configuration, the control device is an RTC6 control card from SCANLAB GmbH, in particular in the configuration currently obtainable on the priority date of the present property right.

The manufacturing device is preferably configured for selective laser sintering. As an alternative or in addition, the manufacturing device is configured for selective laser melting. Alternatively, the manufacturing device is preferably configured for selective electron beam melting. These configurations of the manufacturing device have proved to be particularly advantageous.

The optics device is preferably configured to increase a first width of the energy beam along a specifiable direction, in particular along the vector alignment, relative to a second width of the energy beam perpendicular to the specifiable direction. According to a preferred configuration, the optics device is embodied as an astigmatic optical unit or has an astigmatic optical unit, for example at least one cylindrical lens, preferably two cylindrical lenses. According to another preferred configuration, the optics device is embodied as a non-astigmatic optical unit or has a non-astigmatic optical unit. In particularly preferred fashion, such a non-astigmatic optical unit has at least one anamorphic prism, preferably two anamorphic prisms. Preferably, the optics device moreover has an actuator—in particular a controllable actuator—which is configured to align the beam shape of the energy beam, with the actuator being configured, in particular, to rotate at least one optical element of the optics device. In a preferred configuration, the actuator is embodied as a rotary stage, in particular as a controllable rotary stage or the like.

However, according to a preferred configuration, the optics device may also have at least one controllable deflector element which is configured to generate, by way of dynamic scanning of a local beam shape region, a quasi-stationary intensity distribution in the local beam shape region and thus locally shape the energy beam and align the thus produced quasi-stationary beam shape. In a preferred configuration, the optics device can be in the form of an acousto-optic deflector or a diffractive optical element.

Embodiments of the present invention provide a computer program product which contains machine-readable instructions based on which a planning method according to embodiments of the invention or a method according to one or more of the embodiments described above is carried out on a computing device, in particular a planning device or a control device, when the computer program product is executed on the computing device. In particular, the advantages that have been explained above in connection with the planning device, the planning method and the manufacturing device are afforded in connection with the computer program product.

Embodiments of the present invention also provide a method for the additive manufacture of a component from a powder material by means of a manufacturing device according to embodiments of the invention or a manufacturing device according to one or more of the above-described exemplary embodiments, with a work region being locally selectively irradiated by means of the energy beam in order, by means of the energy beam, to produce the component from the powder material arranged in the work region, with a powder material layer arranged in the work region being impinged by the energy beam in the form of a plurality of irradiation vectors, with, for at least one irradiation vector of the plurality of irradiation vectors, a non-circular beam shape of the energy beam on the work region being aligned relative to a vector alignment of the at least one irradiation vector in a coordinate system on the work region. In particular, the advantages that have been explained previously in connection with the planning device, the planning method, the manufacturing device and the computer program product are afforded in connection with the additive manufacturing method.

If all irradiation vectors for a powder material layer to be irradiated have the same vector alignment and if the vector alignment is merely rotated through a certain angle from powder material layer to powder material layer, there is accordingly also only a need for a one-time setting of the beam alignment prior to the irradiation of each powder material layer. By way of example, this can be implemented by way of a suitable rotation of the optics device or of an optical element of the optics device. By contrast, if different irradiation vectors with different vector alignments are assigned to a powder material layer, there is also a need for a change in the beam alignment, in particular a suitable rotation of the optics device or of the corresponding optical element, within or during the irradiation of the affected powder material layer.

A laser is preferably used as beam producing device. Alternatively, use is preferably made of an electron gun.

The component is preferably manufactured by way of selective laser sintering and/or selective laser melting. Alternatively, the component is manufactured by means of electron beam melting—in particular selective electron beam melting.

A metal or ceramic powder may in particular preferably be used as powder material.

According to some embodiments, provision is made for a different beam shape to be used for each of at least two irradiation vectors of the plurality of irradiation vectors, depending on at least one vector parameter, the at least one vector parameter preferably being selected from a group consisting of: a location of the irradiation vector on the work region, an assignment of the irradiation vector to a specific vector group and a vector length of the irradiation vector.

As an alternative or in addition, provision is preferably made for a different energy input parameter to be used for each of at least two irradiation vectors of the plurality of irradiation vectors, depending on at least one vector parameter, the at least one vector parameter preferably being selected from a group consisting of: a location of the irradiation vector on the work region, an assignment of the irradiation vector to a specific vector group and a vector length of the irradiation vector.

According to some embodiments, provision is made for the energy beam to be displaced multiple times along a contour line of a component contour of a component layer to be produced on the powder material layer in the work region, with a number of the displacements of the energy beam along the contour line being chosen on the basis of at least one contour travel parameter, the at least one contour travel parameter being selected from a group consisting of: the beam shape assigned to at least one irradiation vector adjacent to the contour line and a contour angle between the at least one irradiation vector adjacent to the contour line and the contour line. Preferably, the number of displacements of the energy beam along the contour line is chosen in a defined fashion on the basis of both contour travel parameters of the group defined above.

The method preferably comprises at least one method step, preferably a plurality of method steps, which were explicitly or implicitly described in conjunction with the planning device, in particular in the form of preferred configurations or setups of the planning device, in conjunction with the planning method or in conjunction with the manufacturing device.

Embodiments of the present invention also provide a computer program product which contains machine-readable instructions based on which a method for the additive manufacture of a component or a method according to one or more of the embodiments described above is carried out on a computing device, in particular a control device of a manufacturing device, when the computer program product is executed on the computing device. In particular, the advantages that have been explained previously in connection with the planning device, the planning method, the manufacturing device and the additive manufacturing method are afforded in connection with the computer program product.

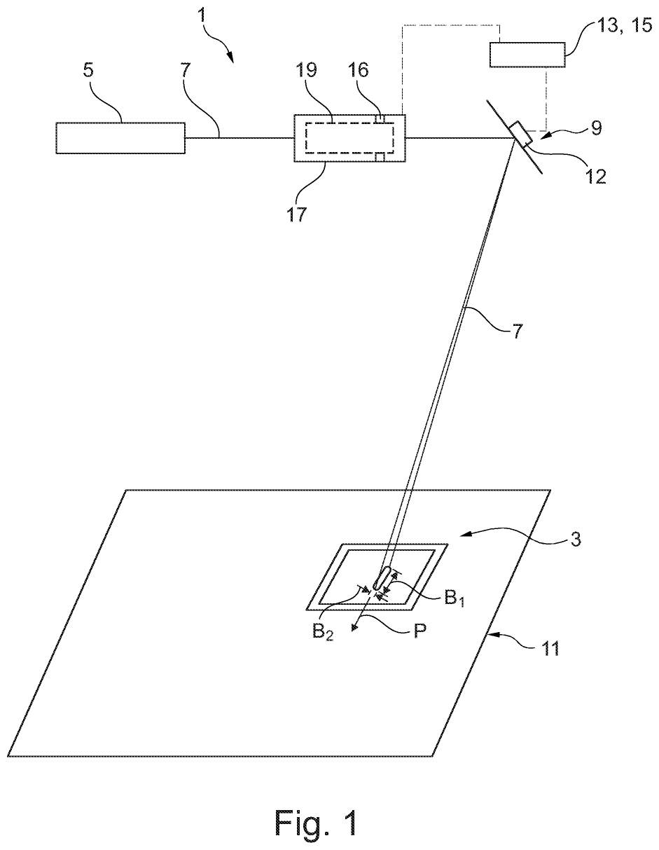

FIG. 1 shows an exemplary embodiment of a manufacturing device 1 for the additive manufacture of a component 3 from a powder material. The manufacturing device 1 has a beam producing device 5 that is configured to produce an energy beam 7. The beam producing device 5 preferably is configured as a laser or comprises a laser, and preferably the energy beam 7 is accordingly a laser beam. However, the energy beam 7 can also be an electron beam in particular. In this case, the beam producing device 5 then is in the form of an electron gun.

The manufacturing device 1 additionally has a scanner device 9 that is configured to locally selectively irradiate a work region 11 with the energy beam 7 in order to produce the component 3 from the powder material arranged in the work region 11 by way of the energy beam 7. For the energy beam 7, the scanner device 9 preferably has a controllable scanner 12, for example a galvanometer scanner.

The manufacturing device 1 further has a control device 13 that is operatively connected to the scanner device 9 and is configured to control the scanner device 9, in particular in order to displace the energy beam 7 within the work region 11.

The control device 13 is designed here as planning device 15. As an alternative, it is possible for the control device 13 to have a planning device 15. However, it is also possible that the planning device 15 is provided separately from the manufacturing device 1, for example as a build processor or as a cloud application.

The planning device 15 is configured to plan the locally selective irradiation of the work region 11 with the energy beam 7.

The manufacturing device 1 moreover has an optics device 17. The optics device 17 has an optical unit 19, in particular an astigmatic optical unit, preferably with at least one cylindrical lens, or a non-astigmatic optical unit, preferably with at least one anamorphic prism. In particular, by way of the optical unit 19, the optics unit 17 is configured to shape the energy beam 7 and to align the latter along a parameterizable direction, in particular along a displacement direction of the energy beam 7 depicted here by way of an arrow P, within the work region 11. However, according to a preferred configuration, the optics unit 17 may also have at least one controllable deflector element which is configured to generate, by way of dynamic scanning of a local beam shape region, a quasi-stationary intensity distribution in the local beam shape region and thus locally shape the energy beam and align the produced quasi-stationary beam shape. In a preferred configuration, the optics device 17 can be in the form of an acousto-optic deflector or a diffractive optical element.

In particular, the optics device 17 is configured to increase a first width B1 of the energy beam 7 along the displacement direction represented by the arrow P relative to a second width B2 of the energy beam 7 perpendicular to the displacement direction, in particular in order to produce an elliptical energy beam 7.

The control device 13 is operatively connected to the optics unit 17 in order to control the optics device 17 which is designed to be controllable, in particular in order to control a controllable actuator 16. In particular, the actuator 16 is configured to rotate the energy beam 7 about its optical axis or beam axis.

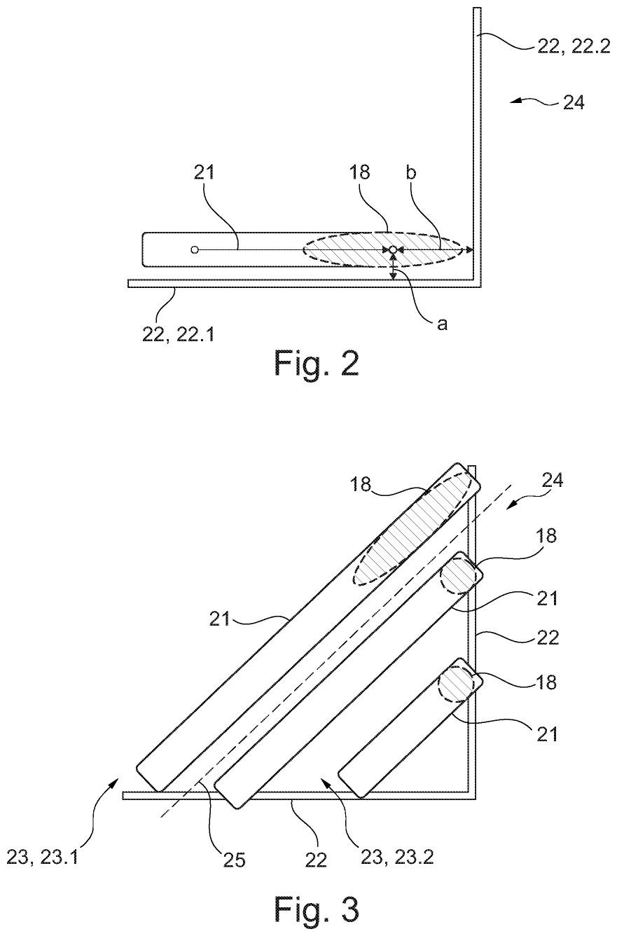

The planning device 15 is configured to obtain a plurality of irradiation vectors 21 (see FIGS. 2 and 3) for irradiating, by means of the energy beam 7, a powder material layer arranged in the work region 11. For at least one irradiation vector 21 of the plurality of irradiation vectors 21, the planning device 15 determines a vector alignment in a coordinate system on the work region 11, and, for at least one irradiation vector 21 of the plurality of irradiation vectors 21, the said planning device specifies a beam alignment for a non-circular beam shape of the energy beam 7 on the work region 11 relative to the vector alignment of the at least one irradiation vector 21.

Preferably, the planning device 15 specifies, for each irradiation vector 21, a beam shape of the energy beam 7 and/or an energy input parameter of the energy beam 7, in particular a beam power and/or displacement speed.

Especially for irradiation vectors 21 in which the assigned beam shape along the vector alignment is non-symmetrical, the planning device 15 moreover ascertains a vector orientation and specifies a beam orientation for the assigned beam shape relative to the vector orientation.

Preferably, the planning device 15, on the basis of at least one vector parameter, allocates a different beam shape and/or a different energy input parameter to each of at least two irradiation vectors 21. The at least one vector parameter may in this case be a location of the irradiation vector 21 on the work region 11. As an alternative or in addition, the vector parameter can be an assignment of the irradiation vector 21 to a specific vector group. As an alternative or in addition, the vector parameter can be a vector length of the irradiation vector 21.

The planning device 15 preferably carries out the determination of the vector alignment and the specification of the beam alignment for each component layer of a plurality of component layers to be produced successively in the work region 11.

If the manufacturing device 1 has a plurality of energy beams 7, the planning device 15 preferably fixedly allocates a certain beam shape to each energy beam 7. It then assigns an energy beam 7 of the plurality of energy beams 7 with a corresponding beam shape to each of the irradiation vectors 21, with the result that the irradiation vectors 21 are each worked through with the energy beam 7 which has the fitting beam shape assigned to the respective irradiation vector 21.

Finally, the manufacturing device 1 preferably carries out a method for manufacturing the component 3 in accordance with the plan created by the planning device 15.

FIG. 2 shows a schematic illustration of a first embodiment of a method for planning locally selective irradiation of the work region 11.

Here, two contour lines 22 of a component contour 24 are depicted, specifically a first contour line 22.1 and a second contour line 22.2, and an irradiation vector 21, which is assigned a non-circular beam shape 18. Two contour distances are specified for the irradiation vector 21, specifically a first contour distance a from the first contour line 22.1 and a second contour distance b from the second contour line 22.2. Here, the contour distances a, b are chosen on the basis of the beam shape 18 and on the basis of a contour angle between the irradiation vector 21 and the respective contour line 22. In this case, the first contour distance a for the first contour line 22.1 running parallel to the irradiation vector 21 is chosen to be smaller than the second contour distance b for the second contour line 22.2 running perpendicular to the irradiation vector 21.

FIG. 3 shows a schematic illustration of a second embodiment of the method for planning locally selective irradiation of the work region 11.

Preferably, the planning device 15 defines a plurality of irradiation regions 23 on the work region 11 and assigns the irradiation vectors 21 to the irradiation regions 23. In the process, the planning device 15 specifies a beam shape 18 of the energy beam 7 for each irradiation region 23, and it defines a division of the irradiation regions 23 on the basis of a vector length of the irradiation vectors 21 in the irradiation regions 23. In this respect, a first irradiation region 23.1 and a second irradiation region 23.2 are illustrated here, with a region boundary 25 between the irradiation regions 23 being chosen on the basis of a predetermined limit vector length. The first irradiation region 23.1 comprises longer irradiation vectors 21 while the second irradiation region 23.2 comprises shorter irradiation vectors 21. A non-circular, elongate beam shape 18 is assigned to the first irradiation region 23.1; a circular beam shape 18 is assigned to the second irradiation region 23.2.

The energy beam 7 is preferably displaced multiple times along the contour lines 22. A number of displacements of the energy beam 7 along the contour lines 22 is preferably chosen on the basis of at least one contour travel parameter. In particular, the number of displacements is preferably chosen on the basis of the beam shape 18 of the irradiation vectors 21 adjacent to the respective contour line 22. As an alternative or in addition, preferably in addition, the number of displacements is chosen on the basis of the contour angle between the adjacent irradiation vectors 21 and the respective contour line 22.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A planning device for planning locally selective irradiation of a work region using an energy beam in order to produce a component from a powder material arranged in the work region, the planning device being configured to:
obtain a plurality of irradiation vectors for irradiating a powder material layer arranged in the work region with the energy beam,
determine a vector alignment in a coordinate system on the work region for at least one irradiation vector of the plurality of irradiation vectors, and
specify, for the at least one irradiation vector, a beam alignment for a non-circular beam shape of the energy beam on the work region relative to the vector alignment of the at least one irradiation vector.

2. The planning device according to claim 1, wherein the planning device is configured to specify
a beam shape of the energy beam and/or
a beam power and/or a displacement speed of the energy beam.

3. The planning device according to claim 1, wherein the planning device is configured to ascertain a vector orientation for at least one irradiation vector of the plurality of irradiation vectors, and to specify, for the at least one irradiation vector, a beam orientation for the beam shape assigned to the at least one irradiation vector.

4. The planning device according to claim 1, wherein the planning device is configured to allocate to each of at least two irradiation vectors of the plurality of irradiation vectors
a different beam shape, and/or
a different energy input parameter,
on the basis of at least one vector parameter, the at least one vector parameter being selected from a group consisting of: a location of the irradiation vector on the work region, an assignment of the irradiation vector to a specific vector group, and a vector length of the irradiation vector.

5. The planning device according to claim 1, wherein the planning device is configured to define a plurality of irradiation regions on the work region and assign the irradiation vectors to the irradiation regions, to specify a beam shape of the energy beam for each irradiation region of the plurality of irradiation regions, and to define a division of the irradiation regions on the basis of a vector length of the irradiation vectors in the irradiation regions.

6. The planning device according to claim 1, wherein the planning device is configured to specify, for at least one irradiation vector of the plurality of irradiation vectors and on the basis of at least one distance parameter, at least one contour distance of the at least one irradiation vector from a contour line of a component contour of a component layer to be produced on the powder material layer in the work region, the at least one distance parameter being selected from a group consisting of: the beam shape assigned to the at least one irradiation vector and a contour angle between the at least one irradiation vector and the contour line.

7. The planning device according to claim 1, wherein the planning device is configured to carry out the determination of the vector alignment and the specification of the beam alignment for each component layer of a plurality of component layers to be produced successively in the work region.

8. The planning device according to claim 1, wherein the planning device is configured to specify, on the basis of at least one contour travel parameter, a number of displacements of the energy beam along a contour line of a component contour of a component layer to be produced on the powder material layer in the work region, the at least one contour travel parameter being selected from a group consisting of: the beam shape assigned to at least one irradiation vector adjacent to the contour line, and a contour angle between the at least one irradiation vector adjacent to the contour line and the contour line.

9. The planning device according to claim 1, wherein the planning device is configured to allocate a specific beam shape to each energy beam of a plurality of energy beams, and to assign to the irradiation vectors a respective energy beam of the plurality of energy beams with corresponding beam shape.

10. A manufacturing device for additive manufacture of components from a powder material, the manufacturing device comprising:
a beam producing device configured to produce an energy beam,
a scanner device configured to locally and selectively irradiate a work region with the energy beam in order to produce a component from the powder material arranged in the work region,
an optics device configured to shape and align the energy beam,
a control device operatively connected to the scanner device and configured to control the scanner device,
wherein the control device is operatively connected to the optics device in order to control the optics device, and
wherein the control device has a planning device according to claim 1.

11. A method for planning locally selective irradiation of a work region using an energy beam in order to produce a component from a powder material arranged in the work region, the method comprising:
determining a vector alignment in a coordinate system on the work region for at least one irradiation vector of a plurality of irradiation vectors for irradiating, using the energy beam, a powder material layer arranged in the work region, and,
for the at least one irradiation vector, specifying a beam alignment for a non-circular beam shape of the energy beam on the work region relative to the vector alignment of the at least one irradiation vector.

12. A computer program product, comprising machine-readable instructions for carrying out a method according to claim 11 on a computing device when the computer program product is executed on the computing device.

13. A method for the additive manufacture of a component from a powder material by means of a manufacturing device according to claim 10, the method comprising:
locally selectively irradiating a work region by means of the energy beam in order to produce the component from the powder material arranged in the work region, impinging the energy beam in the form of a plurality of irradiation vectors on a powder material layer arranged in the work region, and
for at least one irradiation vector of the plurality of irradiation vectors, aligning a non-circular beam shape of the energy beam on the work region relative to a vector alignment of the at least one irradiation vector in an coordinate system on the work region.

14. The method according to claim 13, wherein
a different beam shape and/or
a different energy input parameter
is used for each of at least two irradiation vectors of the plurality of irradiation vectors, on the basis of at least one vector parameter, the at least one vector parameter being selected from a group consisting of: a location of the irradiation vector on the work region, an assignment of the irradiation vector to a specific vector group and a vector length of the irradiation vector.

15. The method according to claim 13 wherein the energy beam is displaced multiple times along a contour line of a component contour of a component layer to be produced on the powder material layer in the work region, with a number of the displacements of the energy beam along the contour line being chosen on the basis of at least one contour travel parameter, the at least one contour travel parameter being selected from a group consisting of: the beam shape assigned to at least one irradiation vector adjacent to the contour line and a contour angle between the at least one irradiation vector adjacent to the contour line and the contour line.
